(19) United States
(12) Patent Application Publication
(10) Pub. No.: US 2010/0109463 A1
(43) Pub. Date: May 6, 2010

(54) Hybrid Five Axis Magnetic Bearing System Using Axial Passive PM Bearing Magnet Paths and Radial Active Magnetic Bearings with Permanent Magnet Bias and Related Method

(75) Inventors: Wei Jiang, Charlottesville, VA (US); Paul E. Allaire, Charlottesville, VA (US)

Correspondence Address: UNIVERSITY OF VIRGINIA PATENT FOUNDATION, 250 WEST MAIN STREET, SUITE 300, CHARLOTTESVILLE, VA, 22902, US

(73) Assignee: UNIVERSITY OF VIRGINIA PATENT FOUNDATION, Charlottesville, VA (US)

(21) Appl. No.: 12/609,938

(22) Filed: Oct. 30, 2009

Related U.S. Application Data
(60) Provisional application No. 61/110,059, filed on Oct. 31, 2008.

(51) Int. Cl. H02K 7/09

(52) U.S. Cl. 310/90.5

(57) ABSTRACT

An extremely energy efficient, compact, integrated hybrid five axis passive and active magnetic bearing system is developed for suspending a rotor within a non-rotating stator without conventional rolling element or fluid film bearings wherein 1) an axial permanent magnetic set of poles generates a magnetic flux path creating an axial repulsive force which keeps the rotor axially centered in the stator without using a thrust disk or radial thrust faces, 2) two radial electromagnetic bearings generate radial magnetic flux paths which create radial forces which keep the rotor radially centered in the housing, and 3) an integrated axial/radial permanent flux path which provides a bias flux for the radial bearings.

### RELATED APPLICATIONS

The present application claims priority from U.S. Provisional Application Ser. No. 61/110,059, filed Oct. 31, 2008, entitled “Hybrid Five Axis Magnetic Bearing System Using Axial Passive PM Bearing Magnet Paths and Radial Active Magnetic Bearings with Permanent Magnet Bias;” the disclosure of which is hereby incorporated by reference herein in its entirety.

### BACKGROUND OF THE INVENTION

Many rotating machines utilize magnetic bearings. This includes pumps, compressor, turbines, motors and many other machines. The most common configuration is a five axis active magnetic configuration using electromagnets for each of the five axes. Typically this means one axial active magnetic thrust bearing acting upon a thrust disk attached to the rotor or radial thrust faces to control axial rotor vibrations and two radial active magnetic bearings, each acting upon the rotor in two directions (typically in the horizontal and vertical directions) to control radial vibrations. While this is a very useful system, it can be improved in several ways pertinent to this invention.

First, the active electromagnets have coils which require coil currents to activate the magnetic fields and have associated power losses. Often some permanent magnets are used to provide a bias flux through the active magnetic bearings to reduce the power consumption. However, the configuration of the active electromagnet/permanent magnet is not an efficient configuration either from the size point of view or from the efficient use of the permanent magnetic flux. Also, the existing configurations usually require a thrust disk or radial thrust faces which may interfere with a fluid flow path through the rotating machine. Permanent magnet passive magnetic bearings have been developed usually as separate components from the active magnetic bearings and with separate magnetic flux paths. Some of the prior art takes steps to combine the flux paths of permanent magnet biasing or use a hybrid combination of active magnetic bearings plus passive permanent magnet bearings, but does so inefficiently.

### SUMMARY OF THE INVENTION

An extremely energy efficient, compact, integrated hybrid five axis passive and active magnetic bearing system and related method is developed for suspending a rotor within a non-rotating stator without conventional rolling element or fluid film bearings wherein 1) an axial permanent magnetic set of poles generates a magnetic flux path creating an axial repulsive force which keeps the rotor axially centered in the stator without using a thrust disk or radial thrust faces, 2) two radial electromagnetic bearings generate radial magnetic flux paths which create radial forces which keep the rotor radially centered in the housing, and 3) an integrated axial/radial permanent magnetic bias flux path which provides a bias flux for the radial bearings. The remaining sixth axis of rotor motion is available for a motor to provide propulsive rotational power. Thus, the rotor is supported in five axes very efficiently with minimum electrical power consumption in the two radial bearings. Another feature of an embodiment of the system and method of the invention is the use of reverse polarity magnets positioned in the stator to create high axial magnetic centering forces and high permanent magnetic bias flux levels for the radial bearings allowing for much higher force capability in both the axial and radial bearings than using single polarity permanent magnets in the stator. One intended application of this hybrid magnetic suspension is for a blood pump which has a direct and streamlined blood flow path axially through the pump enabled by the hybrid five axis magnetic suspension configuration, which does not require a thrust disk or radial thrust faces in the blood flow path. Also, the lack of thrust disk makes assembly of the rotor into the stator much easier. It should be note that an embodiment may be practiced with less than or more than five axes.

An aspect of various embodiments of the present invention comprises, but not limited thereto, the following: supporting a rotor using a passive axial permanent magnetic bearing, to supply the permanent magnetic bias flux for the active radial magnetic bearings but without placing the permanent magnets in the flux path of the active radial bearings. The permanent magnetic bearing for the axial rotor control requires no active currents while simultaneously providing the coupled permanent magnet bias for the active electromagnetic radial bearing control. This approach achieves, among other things, a more compact design of a hybrid five-axis magnetic suspension system without requiring a thrust disk or radial thrust faces on the rotor. This new design achieves a smaller overall size, and is preferred for use in applications such as rotary blood pumps where a straight through blood path allows for a streamlined pump design and does not create low blood flow areas with potential for blood clotting near the thrust disk.

An aspect of various embodiments of the present invention comprises, but not limited thereto, the following: optimizing a hybrid five axis magnetic suspension system with two radial active magnetic bearings and one permanent magnet axial magnetic bearing. The reverse polarity permanent magnets in the stator and dual functional permanent magnets in the rotor act as passive axial PM bearings and also act as the bias magnets for active radial magnetic bearings. No permanent magnets are placed in the active magnetic bearing control flux path. No thrust disk or radial thrust faces are required for this magnetic suspension system, unlike all others cited by conventional hybrid five axis systems. Also, the power consumption and size are minimized with this magnetic configuration.

An aspect of an embodiment of the present invention may comprise a rotor having a combined axial and radial flux path. The rotor may be configured to be activated by design of the reverse polarity staked permanent magnets in a stator. The rotor may comprise of a single polarity dual functional permanent magnets. The rotor may be configured to generate an axial force load capacity without requiring a thrust disk or radial thrust faces and to create a permanent magnet bias flux in both radial electromagnets so as to produce both permanent magnetic axial load capacity and active electromagnetic radial load capacity at both ends of the rotating member. The combined axial/radial flux paths may be created without the active magnetic component flux paths crossing the permanent magnet bias flux path, thereby producing a highly efficient axial permanent magnetic and radial active electromagnetic suspension with permanent magnetic bias and without requiring a thrust disk or radial thrust faces. The reverse polarity axial permanent magnets in the stator and the single polarity permanent magnets in the rotor may be configured to provide high axial stiffness while at the same time providing high magnetic bias for the radial active magnetic bearings without requiring a thrust disk or radial thrust faces. The bias magnet may be located in the stator and the reverse polarity axial permanent magnets or other materials may be located in the rotor.

An aspect of an embodiment of the present invention may comprise a method for providing a five axis passive and active magnetic bearing system for suspending a rotor within a non-rotating stator without the need for a rolling element or fluid film bearings. The rotor, for example, may comprise, but not limited thereto, the following: 1) an axial permanent magnetic set of poles generates a magnetic flux path creating an axial repulsive force which keeps the rotor axially centered in the stator, 2) two radial electromagnetic bearings generate radial magnetic flux paths which create radial forces which keep the rotor radially centered in the housing, and 3) an integrated axial/radial permanent magnetic bias flux path which provides a bias flux for the radial bearings. Further, an additional sixth axis of the rotor motion may be available for a motor to provide propulsive rotational power, wherein the rotor being supported in five axes.

These and other objects, along with advantages and features of various aspects of embodiments of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 schematically illustrates the hybrid five axis radial active magnetic bearing with permanent magnetic bias and passive axial permanent magnetic bearing, where the bias permanent magnet is on rotor. It may be noted that no thrust disk or radial thrust faces are required allowing for a streamlined hybrid suspension system which is easy to assemble simply by sliding the rotor into the stator.

FIG. 2 illustrates the left side active magnetic bearing end view, corresponding to FIG. 1.

FIG. 3 schematically illustrates the hybrid five axis radial active magnetic bearing with permanent magnet bias and passive axial permanent bearing, wherein the bias permanent magnet is located on the stator.

FIG. 4 schematically illustrates another configuration of the hybrid five axis radial active magnetic bearing including a permanent magnetic bias and passive axial permanent magnetic bearing, where the bias permanent magnet is on the stator.

### DESCRIPTION OF EXEMPLARY EMBODIMENTS

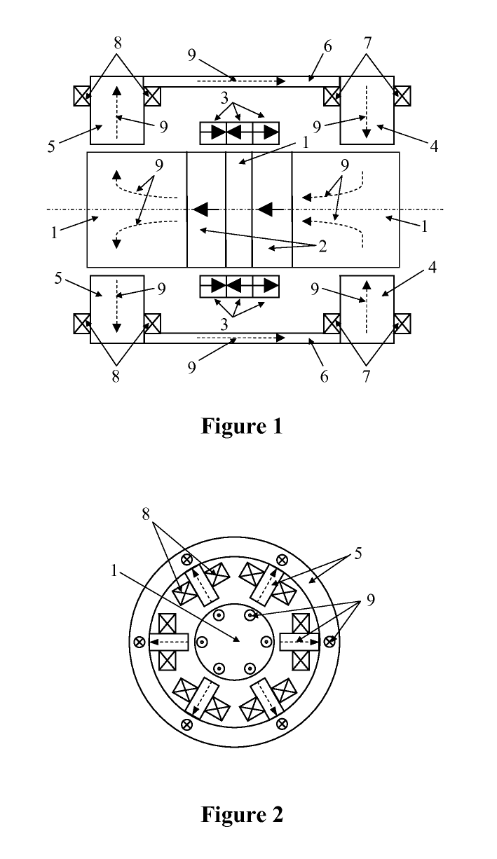

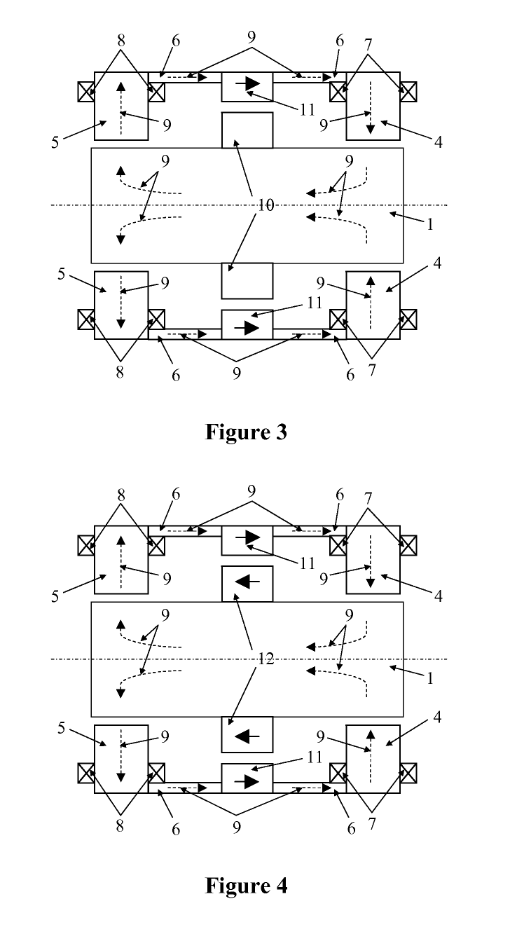

In an embodiment the rotor 1 may be comprised of soft magnetic materials and the dual functional permanent magnets 2 (in FIGS. 1) are located in the rotor. The reverse polarity stacked permanent magnets 3 (in FIG. 1) are located in the stator. The right radial active magnetic bearing stator lamination 4 and the left radial active magnetic bearing stator lamination 5 may be comprised of silicon iron lamination. The stator flux linkage component 6 may be comprised of soft magnetic materials. The right side active magnetic bearing stator coils 7 and the left side active magnetic bearing stator coils 8 control radial forces acting upon the rotor. The left side active magnetic bearings may comprise of a stator lamination 5 and stator coils 8, while the right side active magnetic bearing may comprise of the stator lamination 4 and stator coils 7. The permanent magnetic bias flux path 9 provides the bias flux for both left and right side of the active radial bearings as shown by the dashed arrow lines. The passive axial PM bearing rotor portion 10 (in FIG. 3) provides compensation for axial forces on the rotor. The dual functional permanent magnet 11 (in FIGS. 3 and 4) is located in the stator. The permanent magnet rotor component 12 (in FIG. 4) provides the magnetic flux for the passive axial bearing.

In an aspect of an embodiment, as schematically shown in FIG. 1, the dual functional permanent magnets 2 form the rotor portion of the axial passive permanent magnet bearing (consisting of 2 and 3). There are two active radial magnetic bearings at the right and left side of the dual functional permanent magnets 2. The dual functional permanent magnets 2 may be split into two components, to increase the performance of the passive magnetic bearing. The stator has reverse polarity stacked permanent magnet 3, while the rotor has two singly polarized dual functional permanent magnets 2, providing a simplified permanent magnetic bias flux path 9 through the rotor unlike conventional devices. The stator may have a separate permanent magnetic bias flux linkage component 6 employed to avoid placing the reverse polarity stacked permanent magnets 3 in the active radial magnetic bearing flux paths. Unlike conventional devices, this embodiment provides axial centering of the rotor in the stator without any thrust disk or radial thrust faces on the rotor. In one application expected application to a blood pump, the axial magnetic suspension provides for a streamlined design which does not obstruct the path of any fluids through the clearance space around the rotor.

The permanent magnetic bias flux path 9 follows the path shown by the dashed arrows in FIG. 1. The path 1) starts from dual functional permanent magnets 2 in the center of the rotor 1 in FIG. 1., 2) then it comes left axially into rotor 1 until it turns upward about 90 degrees into the left radial active magnetic bearing stator lamination 5, 3) after it enters into the left radial active magnetic bearing stator lamination 5, it turns rightward about 90 degrees and passes into the stator bias flux linkage component 6, 4) it then passes into the right radial active magnetic bearing stator lamination 4, 5) the permanent magnetic bias flux path 9 turns another approximately 90 degrees until it flows radially inward through the right radial active magnetic bearing stator lamination 4, and 6) it passes back into the rotor 1 and make another approximately 90 degrees turn returning to dual functional permanent magnets 2. In the bottom of FIG. 1, it has a similar path. FIG. 2 shows an end view of the left radial active magnetic bearing geometry consisting of rotor 1, stator lamination 5 and stator coils 8 and permanent magnet bias flux path 9.

An aspect of various embodiments of the present invention may provide a number of advantages, such as but not limited thereto, the following: the dual functional permanent magnets 2 are not in the path of active control flux loop, so it is more efficient to generate active control fluxes. Also, the permanent magnetic bias flux biases the active radial magnetic bearings into a homopolar configuration, which reduces rotation loss in the rotor. The passive axial PM bearing also has the advantage of using reverse polarity stacked permanent magnets 3 at the stator, and the split dual functional permanent magnets 2 configuration increases the stiffness of the passive axial permanent magnet bearing. It may be noted that no thrust disk or radial thrust faces are required to generate the magnetic flux paths necessary to center the rotor in the stator with this configuration, plus the rotor is easy to assemble into the stator.

In another embodiment, as shown in FIGS. 3, 4, the dual functional permanent magnet 11 are located in the stator portion of axial passive permanent magnet bearing. The passive axial PM bearing rotor portion 10 is a soft magnetic material target as shown in FIG. 3, or consists of one or more permanent magnet rotor components 12 to increase the performance of the passive magnetic bearing shown in FIG. 4. The stator has two bias flux linkage components 6. There are two active radial magnetic bearings, one at each side of the bias permanent magnet. Again, no thrust disk or radial faces are required in this preferred embodiment.

The following patents, applications and publications as listed below and throughout this document are hereby incorporated by reference in their entirety herein. The devices, systems, and methods of various embodiments of the invention disclosed herein may be utilized as part of, but not limited thereto, the following: blood pump, an artificial heart pump, vacuum pumps, other pump types, compressor, turbines, motors and many other machines. The devices, systems, and methods of various embodiments of the invention disclosed herein may utilize aspects disclosed in the following references, applications, publications and patents and which are hereby incorporated by reference herein in their entirety:

1. U.S. Pat. No. 4,597,613, Sudo, H., “Electromagnetic Bearing,” Jul. 1, 1986.

2. U.S. Pat. No. 5,507,629, Jarvik, R., “Artificial Hearts with Permanent Magnet Bearings,” Apr. 16, 1996.

3. U.S. Pat. No. 6,118,199, Lembke, T., “Magnetic Bearings,” Sep. 12, 2000.

4. U.S. Pat. No. 6,201,329 B1, Chen, H., “Pump Having Magnetic Bearing for Pumping Blood and the Like”, Mar. 13, 2001.

5. U.S. Pat. No. 6,259,179 B1, Fukuyama et al., “Magnetic Bearing System,” Jul. 10, 2001.

6. U.S. Pat. No. 6,595,762 B2, Khanwilkar et al., “Hybrid Magnetically Suspended and Rotated Centrifugal Pumping Apparatus and Method,” Jul. 22, 2003.

7. U.S. Pat. No. 6,603,230 B1, Abel, S., “Active Magnetic Bearing Assembly Using Permanent Magnet Biased Homopolar and Reluctance Centering Effects”, Aug. 5, 2003.

8. U.S. Pat. No. 6,700,258 B2, McMullen, et al., “Magnetic Thrust Bearing with Permanent Bias Flux”, Mar. 2, 2004.

9. U.S. Pat. No. 6,727,617 B2, McMullen, et al., “Method and Apparatus for Providing Three Axis Magnetic Bearing Having Permanent Magnets Mounted on Radial Pole Stack”, Apr. 27, 2004.

10. U.S. Pat. No. 6,794,780 B2, Silber, et al., “Magnetic Bearing System”, Sep. 21, 2004.

11. U.S. Pat. No. 6,806,605, Gabrys, C., “Permanent Magnetic Bearing”, Oct. 19, 2004.

12. U.S. Pat. No. 6,877,963 B2, Beyer, et al., “Vacuum Pump”, Apr. 12, 2005.

13. U.S. Pat. No. 6,885,121 B2, Okada, et al., “Controlled Radial Magnetic Bearing”, Apr. 26, 2005.

14. International Patent Application Serial No. PCT/US2008/70073, Allaire, et al., “Self Sensing Integrated System and Method for Determining the Position of a Shaft in a Magnetic Bearing”, filed Jul. 15, 2008 (International Patent Application Publication No. WO 2009/012258 A1, published Jan. 22, 2009).

The following patents, applications and publications as listed below and throughout this document are hereby incorporated by reference in their entirety herein. The devices, systems, and methods of various embodiments of the invention disclosed herein may be utilized as part of, but not limited thereto, the following: blood pump, an artificial heart pump, vacuum pumps, other pump types, compressor, turbines, motors and many other machines. The devices, systems, and methods of various embodiments of the invention disclosed herein may utilize aspects disclosed in the following references, applications, publications and patents and which are hereby incorporated by reference herein in their entirety:

1. International Patent Application Serial No. PCT/US2008/070073, filed Jul. 15, 2008, entitled “Self Sensing Integrated System and Method for Determining the Position of a Shaft in a Magnetic Bearing”, published Jan. 22, 2009, International Patent Application Publication No. WO 2009/012258.

2. U.S. patent application Ser. No. 11/925,294, filed Oct. 26, 2007, entitled “Implantable Centrifugal Blood Pump with Hybrid Magnetic Bearings”, published Oct. 2, 2008, U.S. Patent Application Publication No. 2008/0240947 A1.

3. International Patent Application Serial No. US2006/025515, filed Jun. 29, 2006, entitled “Method and System for Energy Returning Ankle Foot Orthosis (ERAFO)”, published Jan. 11, 2007, International Patent Application Publication No. WO 2007/005574 4. International Patent Application Serial No. US2004/031582, filed Sep. 27, 2004, entitled “Axial-Flow Blood Pump with Magnetically Suspended, Radially and Axially Stabilized Impeller”, published Apr. 7, 2005, International Patent Application Publication No. WO 2005/030296 A2.

5. U.S. patent application Ser. No. 10/950,176, filed Sep. 24, 2004, entitled “Streamlined Unobstructed One-Pass Axial-Flow Pump”, published Jun. 23, 2005, U.S. Patent Application Publication No. US2005/0135942, U.S. Pat. No. 7,229,258, issued Jun. 12, 2007

6. U.S. patent application Ser. No. 10/949,884, filed Sep. 24, 2004, entitled “Axial-Flow Blood Pump with Magnetically Suspended, Radially and Axially Stabilized Impeller”, published Jun. 23, 2005, U.S. Patent Application Publication No. US2005/0135948, U.S. Pat. No. 7,070,398 B2, issued Jul. 4, 2006.

7. U.S. patent application Ser. No. 09/968,690, filed Oct. 1, 2001, entitled “Hybrid Magnetically Suspended and Rotated Centrifugal Pumping Apparatus and Method”, published Jul. 18, 2002, U.S. Patent Application Publication No. US 2002/0094281, A1, U.S. Pat. No. 6,595,762, issued Jul. 22, 2003.

8. U.S. patent application Ser. No. 09/673,922, filed Aug. 24, 2001, entitled “Implantable Centrifugal Blood Pump with Hybrid Magnetic Bearings”, U.S. Pat. No. 7,462,019, issued Dec. 9, 2008.

9. International Patent Application Serial No. US2000/33415, filed Dec. 8, 2000, entitled “Electromagnetically Suspended And Rotated Centrifugal Pumping Apparatus And Method”, published Jun. 14, 2001, International Patent Application Publication No. WO 2001/42653.

10. U.S. patent application Ser. No. 09/602,471, filed Jun. 23, 2000, entitled “Pump Having A Magnetically Suspended Rotor With One Active Control Axis”, U.S. Pat. No. 6,394,769, issued May 28, 2002.

11. U.S. patent application Ser. No. 09/459,146, filed Dec. 10, 1999, entitled “Electromagnetically Suspended and Rotated Centrifugal Pumping Apparatus and Method”, U.S. Pat. No. 6,302,661, issued Oct. 16, 2001.

12. International Patent Application Serial No. PCT/US99/08870, filed Apr. 2, 1999, entitled “Implantable Centrifugal Blood Pump with Hybrid Magnetic Bearins”, published Oct. 28, 1999, International Patent Application Publication No. WO 99/53974.

13. U.S. patent application Ser. No. 09/064,352, filed Apr. 22, 1998, entitled “An Implantable Centrifugal Blood Pump with Hybrid Magnetic Bearings”.

14. International Patent Application Publication No. PCT/US97/07567, filed May 5, 1997, entitled “Electromagnetically Suspended And Rotated Centrifugal Pumping Apparatus And Method”, published Nov. 13, 1997, International Application Publication No. WO 97/42414.

15. International Patent Application Publication No. PCT/US97/07566, filed May 5, 1997, entitled “Hybrid Magnetically Suspended And Rotated Centrifugal Pumping Apparatus And Method”, published Nov. 13, 1997, International Patent Application Publication No. WO 97/42413.

16. U.S. patent application Ser. No. 08/850,598, filed May 2, 1997, entitled “Hybrid Magnetically Suspended and Rotated Centrifugal Pumping Apparatus and Method,” U.S. Pat. No. 6,074,180 issued Jun. 13, 2000.

17. U.S. patent application Ser. No. 08/850,156, filed May 2, 1997, entitled “Electromagnetically Suspended and Rotated Centrifugal Pumping Apparatus and

19. U.S. patent application Ser. No. 07/612,194, filed Nov. 13, 1990, entitled “Magnetic Bearings For Pumps, Compressors, And Other Rotating Machinery”, U.S. Pat. No. 5,355,042, issued Oct. 11, 1994.

20. U.S. patent application Ser. No. 07/562,339, filed Aug. 3, 1990, entitled “Magnetic Bearing Systems”, U.S. Pat. No. 5,347,190.

21. U.S. patent application Ser. No. 07/359,772, filed May 31, 1989, entitled “Magnetic Bearing Systems (Unofficial title)”.

22. U.S. patent application Ser. No. 07/242,264, filed Sep. 9, 1988, entitled “Magnetic Bearings for Pumps, Compressors, And Other Rotating Machinery (Unofficial Title)”.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A rotor having a combined axial and radial flux path, wherein:
said rotor being configured to be activated by a configuration of reverse polarity staked permanent magnets in a stator;
said rotor comprising a single polarity dual functional permanent magnets;
said rotor being configured to generate an axial force load capacity without requiring a thrust disk or radial thrust faces and configured to create a permanent magnet bias flux in both radial electromagnets so as to produce both permanent magnetic axial load capacity and active electromagnetic radial load capacity at both ends of the rotating member.

2. The rotor of claim 2, wherein the combined axial/radial flux paths are created without the active magnetic component flux paths crossing the permanent magnet bias flux path, thereby producing a highly efficient axial permanent magnetic and radial active electromagnetic suspension with permanent magnetic bias and without requiring a thrust disk or radial thrust faces.

3. The rotor of claim 2, wherein the reverse polarity axial permanent magnets in said stator and said single polarity permanent magnets in said rotor being configured to provide high axial stiffness while at the same time providing high magnetic bias for said radial active magnetic bearings without requiring a thrust disk or radial thrust faces.

4. The rotor of anyone of claims 1, 2 or 3, wherein said bias magnet is located in said stator and said reverse polarity axial permanent magnets or other materials is located in said rotor.

5. The rotor of anyone of claims 1, 2 or 3, wherein said bias magnet is located in said stator.

6. The rotor of anyone of claims 1, 2 or 3, wherein said reverse polarity axial permanent magnets or other materials is located in said rotor.

7. A method for providing a five axis passive and active magnetic bearing system for suspending a rotor within a non-rotating stator without the need for a rolling element or fluid film bearings.

8. The method of claim 7, wherein said rotor comprises:
an axial permanent magnetic set of poles generates a magnetic flux path creating an axial repulsive force which keeps the rotor axially centered in the stator,
two radial electromagnetic bearings generate radial magnetic flux paths which create radial forces which keep the rotor radially centered in the housing, and
an integrated axial/radial permanent magnetic bias flux path which provides a bias flux for the radial bearings.

9. The method of claim 8, further comprising a remaining sixth axis of said rotor motion available for a motor to provide propulsive rotational power, wherein said rotor being supported in five axes.
